(19) United States
(12) Patent Application Publication
(10) Pub. No.: US 2014/0318671 A1
(43) Pub. Date: Oct. 30, 2014

(54) WASTE TRANSFER SYSTEM

(71) Applicant: LIPPERT COMPONENTS MANUFACTURING, INC., Elkhart, IN (US)

(72) Inventor: Douglas R. SWARTS, Hollister, CA (US)

(21) Appl. No.: 14/264,126

(22) Filed: Apr. 29, 2014

Related U.S. Application Data
(60) Provisional application No. 61/817,056, filed on Apr. 29, 2013.

(51) Int. Cl. E03F 1/00; F16L 35/00

(52) U.S. Cl. CPC E03F 1/008; F16L 35/005
USPC 141/382

(57) ABSTRACT

A waste transfer system includes a sewer hose, a sewer nozzle connected to the sewer hose, and an adapter configured for quick connection to the sewer nozzle. The sewer nozzle may be permanently connected to the sewer hose. The sewer nozzle may incorporate a quick disconnect feature to enable quick connection to the adapter. The adapter may be at least partially transparent to enable viewing of contents thereof.

### CROSS-REFERNCE TO RELATED APPLICATION

This application claims benefit of U.S. Provisional Patent Appl. No. 61/817,056, filed on Apr. 29, 2013.

### BACKGROUND OF THE DISCLOSURE

This disclosure is directed to a waste transfer system as might be used to transfer waste water from a waste water system of a recreational vehicle (“RV”), travel trailer, or other vehicle having living quarters or on-board water systems (individually or collectively referred to herein as RVs) to an inlet of a sewer system configured to receive such waste water. (The terms “waste,” “waste water” and “sewage” may be used interchangeably herein.)

An RV may include one or more waste water tanks that receive and collect waste water from the drains of sinks, showers, and toilets that may be installed on the RV. Such waste water tanks have a finite volume and need to be drained from time to time. The RV may include some form of waste transfer hose and nozzle arrangement that may be connected to a sewer inlet connection as might be found at an RV park or other facility able to receive waste water from RVs. Such nozzles and sewer inlet connections, however, are not standardized. As such, a particular RV's sewer nozzle might not be especially compatible with a particular facility's sewer inlet connection. Draining waste water tanks using a sewer nozzle incompatible with the sewer inlet connection can result in leakage and spills, which can be difficult and unpleasant to clean up.

### SUMMARY OF THE DISCLOSURE

The present disclosure shows and describes illustrative embodiments of a sewer hose, sewer nozzle, and sewer nozzle adapters enabling connection of the sewer nozzle to various different sewer inlet connections.

### BRIEF DESCRIPTION OF THE DRAWINGS

FIG. 1 is a side view of an illustrative sewer hose/nozzle assembly;

FIG. 2 is a side view of another illustrative sewer hose/nozzle assembly;

FIG. 3 is a side view of an illustrative sewer nozzle incorporating a shut off valve and showing an actuator for the shut off valve in both “open” and “closed” positions;

FIG. 4 is a side view of an illustrative adapter;

FIG. 5 is a side view of another illustrative adapter;

FIG. 6 is a side view of a further illustrative adapter;

FIG. 7 is a side view of yet another illustrative adapter;

FIG. 8 is a side view of the sewer hose/nozzle assembly of FIG. 1 connected to an illustrative adapter;

FIG. 9 is a side view of an illustrative extension hose/nozzle assembly coupled between the sewer hose/nozzle assembly of FIG. 1 and an illustrative adapter;

FIG. 10 is a schematic drawing showing the sewer hose/nozzle assembly of FIG. 1 and adapter of FIG. 5 interfaced with a waste water system of, for example, a recreational vehicle; and

FIG. 11 is a side view of an end cap or plug that may be inserted into the outlet of a sewer nozzle.

### DETAILED DESCRIPTION OF THE DRAWINGS

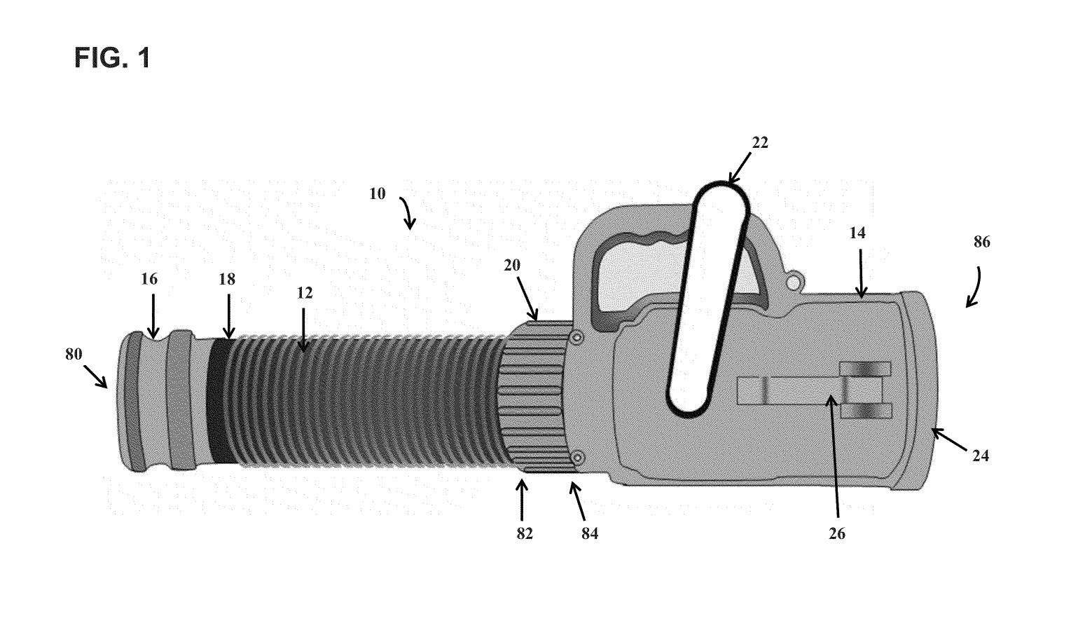

FIG. 1 shows an illustrative sewer hose/nozzle assembly 10 including a sewer hose 12 connected to a sewer nozzle 14. Hose 12 is shown as an extendable /retractable sewer hose having a compression ratio of about 4:1. In other embodiments, hose 12 could have other, greater or lesser, compression ratios. In further embodiments, hose 12 need not be of the compressible/extendable variety. U.S. Pat. No. 8,616,241 discloses one suitable form of hose 12.

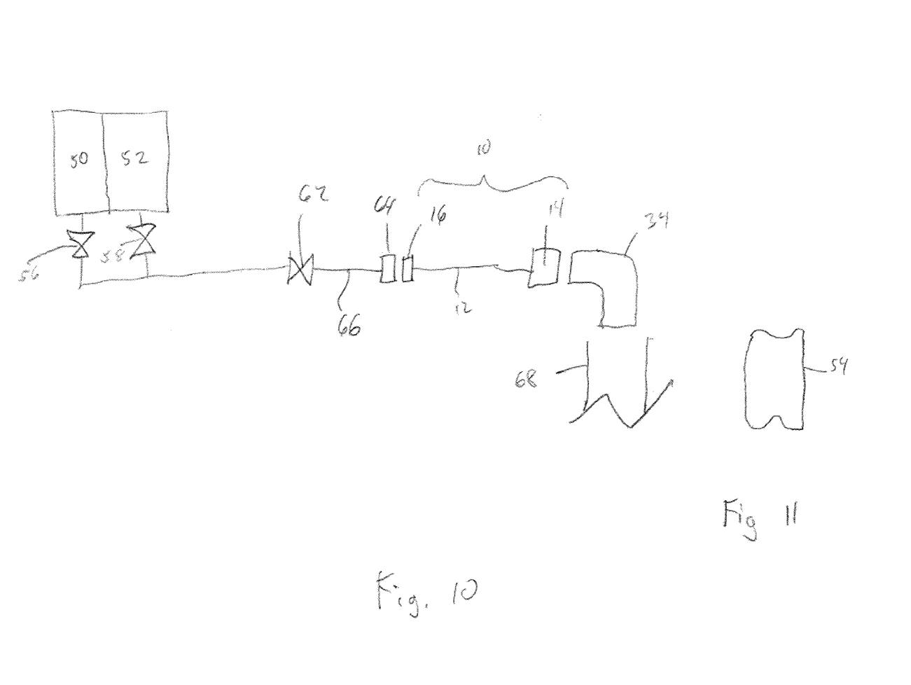

A first (or inlet) end 80 of hose 12 may terminate in a cuff 18, which is attached to a quick disconnect fitting 16 using a barbed, glued, or other form of termination or connection. Although quick disconnect fitting 16 is shown as a male cam-lock connector configured for attachment to a mating female cam-lock connector (not shown), quick disconnect fitting 16 could be embodied in other ways. For example, it could be embodied as a female cam-lock connector configured for attachment to a mating male cam-lock connector, a male or female bayonet fitting, or another type of quick disconnect fitting. In use, as best shown in FIG. 10, fitting 16 may be coupled to a mating fitting 64 connected to, and/or in fluid communication with an outlet 66 of one or more waste water tanks 50, 52 (tank 50 may be a grey water tank and tank 52 may be a black water tank). One or more manual or power-operated valves 56, 58, 62 may be installed between the waste water tank and outlet 66 and/or fitting 16 to selectively enable isolation of the waste water tank(s) from fluid communication with fitting 10.

A second (or outlet) end 82 of hose 12 may terminate in a cuff (not shown) similar to cuff 18. The second end of hose 12 is attached to a first (or inlet) end of nozzle 14. The second end of hose 12 is shown as being permanently attached to nozzle 14 using a press-on fitting 20. For example, fitting 20 may be a male barb-type fitting that allows the end of hose 12 to be pressed thereon in a first direction (that is, the direction in which the barbs point), but does not allow the hose to be readily or inadvertently removed therefrom. In other embodiments, hose 12 could be permanently or removable attached to nozzle 14 using another form of fitting, for example, a male screw-in fitting. As another alternative, hose 12 could be glued to the fitting.

Nozzle 14 includes a body having a first end (sometimes referred to herein as the nozzle inlet end or nozzle inlet) 84, as discussed above, and a second end (sometimes referred to herein as the nozzle outlet end or nozzle outlet) 86. Nozzle inlet and outlet 84, 86 have generally collinear flow axes. An ergonomic grip or other grip or handle 30 may be formed with or attached to the nozzle body.

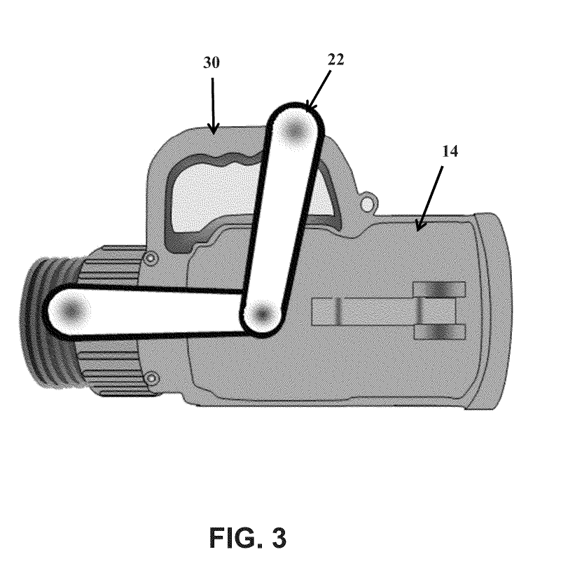

Nozzle 14 may incorporate, or function as, a valve operable by a valve actuator 22. Valve actuator 22 is shown as a manually-operable handle or lever, but could be embodied in other forms, as well. In such an embodiment, the body of nozzle 14 may function as a valve body and may define or otherwise include a valve seat (not shown). A valve disc, ball, gate, flapper, butterfly or the like (sometimes collectively or individually referred to herein as a valve disc) (not shown), may be provided in operable association with a valve seat and operably connected to valve actuator 22. Valve actuator 22 may be operated between a first (or closed) position, for example, the generally vertical position as shown in FIG. 1 and a second (or open) position, for example, the generally horizontal position as shown in FIG. 3. Positioning valve actuator 22 in the closed position places the valve disc against the seat to disable or block fluid communication between the nozzle inlet and outlet. Positioning valve actuator 22 in the open position places the valve disc off of the seat to enable fluid communication between the nozzle inlet and outlet. In other embodiments, actuator 22 could be a locally and/or remotely operated actuator, for example, an air actuator, an electric actuator, a hydraulic actuator, or any form of power operated actuator.

In some embodiments, nozzle 14 may be provided with a remote control configured to remotely operate power-operated valves (not shown) at the outlets of the waste water tanks (not shown) to which hose 12 might be connected. Such a remote control could be wired or wireless. If wired, the wiring could be integrated with hose/nozzle assembly 10, with a connector provided at the inlet end of hose 12 for connection with a mating connector in electrical communication with operators for the power-operated valves.

The outlet of nozzle 14 may be provided with a quick disconnect fitting, or it may be configured to receive a quick disconnect fitting. The outlet of nozzle 14 is shown as being configured as a female cam-lock connector. Cam-lock release levers 26 are provided on the body of nozzle 14 and are operable to positively engage with a mating male cam-lock connector, as will be discussed further below. A single cam-lock release lever 26 is shown and is sufficient, but additional cam-lock release levers 26 could be provided as desired. Other forms of quick disconnect fittings could be used, as well.

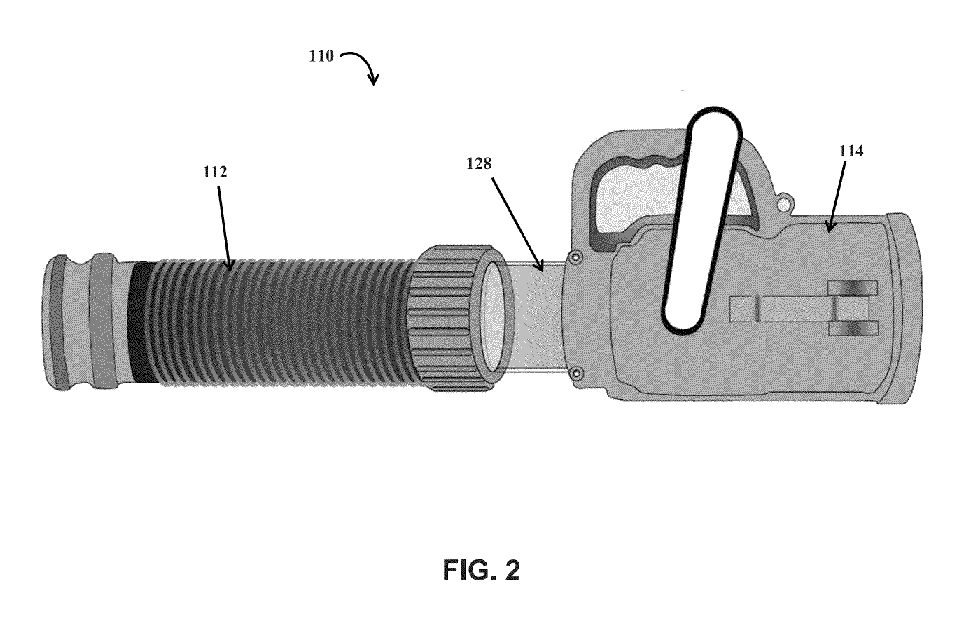

FIG. 2 shows another illustrative sewer hose/nozzle assembly 110 including a sewer hose 112 connected to a sewer nozzle 114. Assembly 110 is similar to assembly 10 except that assembly 110 further includes a generally transparent viewing window 128 disposed between hose 112 and nozzle 114. In use, viewing window 128 enables a user to view the contents of hose 12 as it is being discharged through nozzle 14.

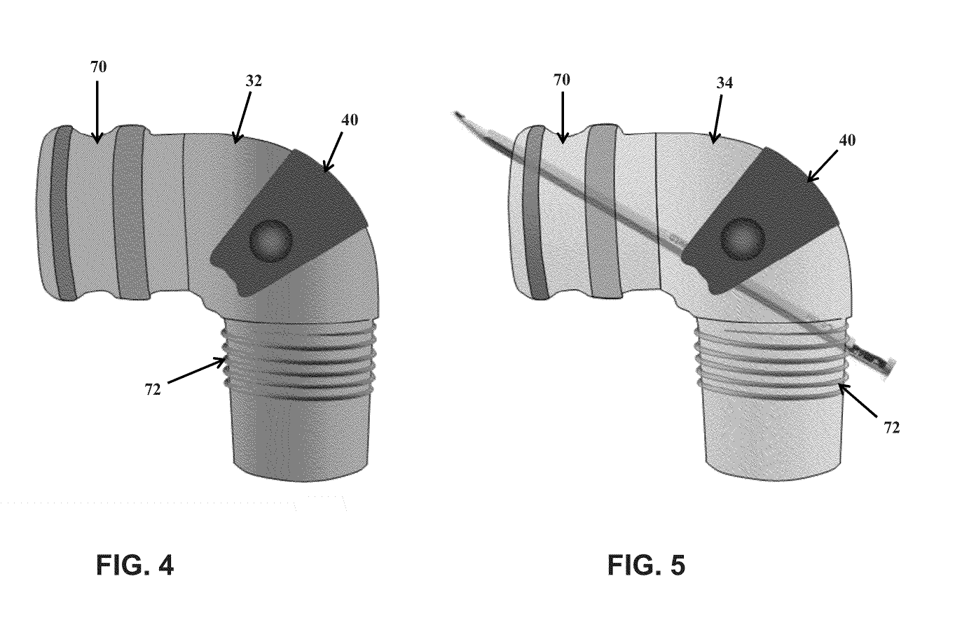

FIGS. 4-7 illustrate various adapters 32, 34, 36, 38 that could be used with hose/nozzle assemblies 10, 110. Each of adapters 32, 34, 36, 38 includes a body having a first (inlet) end and a second (outlet) end in fluid communication with the inlet end. The inlet end is generally at a right angle to the outlet end. Put another way, fluid through the adapters generally turns through a right angle between the inlet end and the outlet end. In other embodiments, the inlet end could be at a greater or lesser angle to the outlet end. For example, the inlet end may be at a 45 degree angle to the outlet end or generally collinear with the outlet end.

The inlet end 70 of adapters 32, 34, 36, 38 is shown as a male cam-lock structure configured to mate with the female cam-lock structure at the outlet of nozzle 14. In other embodiments, inlet end 70 of adapters 32, 34, 36, 38 could be configured as any other suitable quick disconnect structure complementary to the particular quick disconnect structure that may be provided at the outlet end of nozzle 14. The foregoing structures may be integrally formed into adapters 32, 34, 36, 38. Adapters 32, 34, 36, 38 may be molded from plastic or made from any other suitable material in any suitable way. Adapters 32, 34, 36, 38 are shown as including an optional grip portion 40 made of a material or having a surface treatment enabling enhanced gripability of adapters 32, 34, 36, 38, particularly if adapters 32, 34, 36, 38 are made of a material having a low coefficient of friction when dry and especially when wet. For example, grip portion 40 may be made of a rubber material glued, bonded, or otherwise attached to the body of adapters 32, 34, 36, 38.

FIG. 4 shows a first illustrative adapter 32 having an inlet as described above and a threaded outlet portion 72. Threaded outlet portion 34 may be integrally formed with adapter 32. Threaded outlet portion 72 may, but need not be, complementary to a mating threaded portion of a sewer inlet pipe 68. That is, a sewer inlet pipe 68 may, but need not, have a threaded portion that may or may not be complementary to threaded outlet portion 72 of adapter 32. In other embodiments, threaded outlet portion may be omitted, and the outlet portion of adapter 32 may be substantially free of surface contour, or it may include a ridge configured to receive a step thread or compression fitting accessory, as discussed further below. Adapter 32 is shown as being made of a generally opaque material.

FIG. 5 shows a second illustrative adapter 34 similar to adapter 32 but made of a generally transparent material.

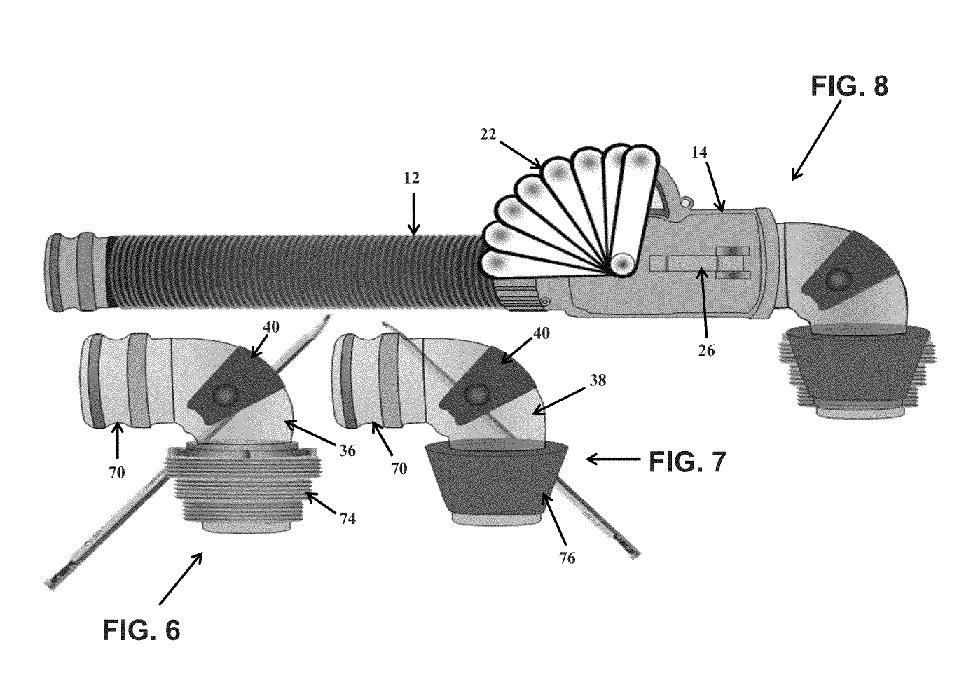

FIG. 6 shows a third illustrative adapter 36 similar to adapter 34 but having a step-threaded outlet portion 74. Step threaded outlet portion 74 is shown as having threaded sections of three different diameters and/or thread pitches that may, but need not, be compatible with certain threaded sewer inlet connections 68. Step threaded outlet 74 could be integrally formed with adapter 36 or it could be embodied a separate accessory piece that could be post-attached to adapter 32, 34. Such an accessory piece could be embodied as a generally annular section having an interior side wall configured to receive the outlet portion of adapter 32, 34 therethrough. The interior side wall of adapter 36 could define a circumferential ridge proud of the interior side wall configured to snap over threaded portion 72 of adapter 32, 34 (or a ridge that might be provided in lieu of threaded portion 72, as discussed above). So assembled, the accessory piece including the step threads could be free to swivel about the outlet portion of adapter 32, 34, yet remain captive thereto.

FIG. 7 shows a fourth illustrative adapter 38 similar to adapter 34 but having a compression-fitting outlet portion 76 (sometimes referred to as a compression donut). Compression donut 76 may be made of rubber or another suitable material. Compression donut 76 could be embodied as a generally annular section having an interior side wall configured to receive the outlet portion of adapter 32, 34 therethrough. The interior side wall could define a circumferential ridge proud of the interior side wall configured to snap over threaded portion 72 of adapter 32, 34 (or a ridge that might be provided in lieu of threaded portion 72, as discussed above). Alternatively, compression donut 76 could be slip fit to an outlet portion of adapter 32, 34 generally free of surface contour.

A pencil is shown in FIGS. 5-7 behind the bodies of adapters 34, 36, 38 to demonstrate their transparency. The pencil is not part of the adapters.

The outlets of the foregoing adapters may be configured for connection to a sewer inlet 68 of a sewer system for receiving waste water. For example, adapters 32, 34, 36 could be threaded into such a sewer inlet, and adapter 38 could be pressed into such a sewer inlet. Such connection preferably, but not necessarily, would be substantially fluid-tight. In some applications, any of adapters 32, 34, 36, 38 could simply be inserted into such a sewer inlet. Such a connection might not be fluid-tight.

FIG. 11 shows an end cap or plug 54 that may be engaged with the outlet of hose nozzle 14 when hose nozzle 14 is not in use. End cap 54 may comprise a quick disconnect fitting, for example, a male cam lock fitting, complementary to the quick disconnect fitting at the outlet of nozzle 14, with a blind or closed “outlet” end. With end cap 54 installed to nozzle 14, fluid communication through nozzle 14 to the environment may be substantially precluded.

FIG. 8 shows hose/nozzle assembly 10 connected to an adapter 36, 38, with valve actuator 22 transitioning between open and closed positions. FIG. 8 should be understood as showing adapter 36 including step threaded outlet portion 74 and adapter 38 including compression fitting outlet portion 76 in the alternative, and not as an adapter including a combined step threaded and compression fitting outlet portion.

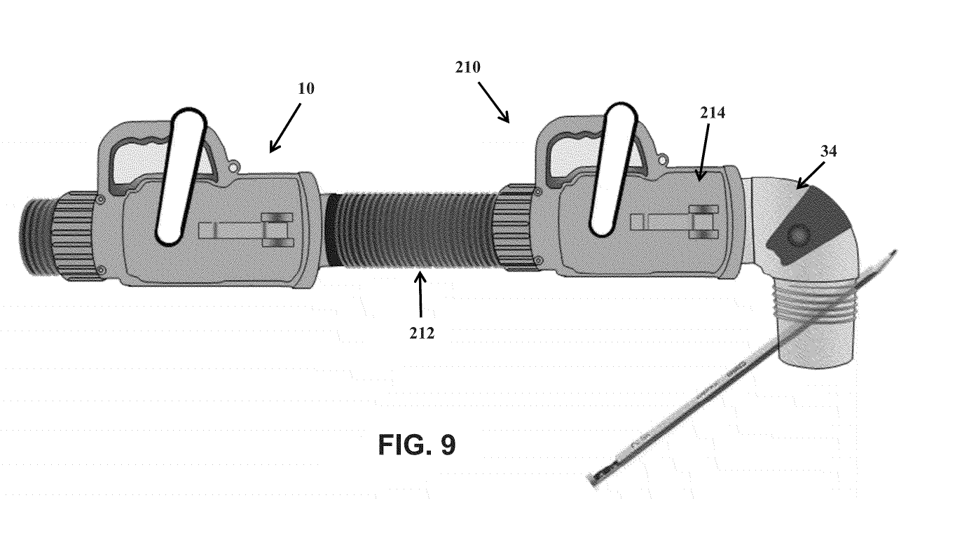

FIG. 9 shows an extension hose/nozzle assembly 210 having a hose 212 and a nozzle 214 connected between nozzle 14 and adapter 34. Extension hose/nozzle assembly 210 may be similar or identical to hose/nozzle assembly 10. In an embodiment (not shown), extension hose/nozzle assembly 210 could be provided with a viewing window similar to viewing window 128 of hose/nozzle assembly 110. Extension hose assembly 210 may be used to extend the reach of sewer hose/nozzle assembly 10.

In an RV application, nozzle 14 and hose 12 may be withdrawn from the RV, for example, from a storage compartment of the RV. The inlet end of hose 12 may be connected to the outlet 66 of one or more waste water tanks 50, 52. A suitable adapter 32, 34, 36, 38 also may be withdrawn from the RV, for example, from the same storage compartment as nozzle 14 and hose 12, or from another storage compartment. The adapter may be connected to the outlet of nozzle 14 by engaging the quick-disconnect structure of the inlet of the adapter with the quick- disconnect structure of the outlet of nozzle 14. Hose 12, nozzle 14, adapter 32, 34, 36, and 38, all intervening connections and connection of hose 12 to outlet 66 may be substantially fluid tight. The outlet of the adapter may then be inserted into or otherwise connected to sewer inlet 68, as discussed above. Alternatively, particularly in embodiments wherein the adapter has a threaded outlet portion, the adapter may be inserted into or otherwise connected to sewer inlet 68, and then connected to nozzle 14.

The user may begin discharging waste water from tanks 50, 52 to sewer inlet 68 by opening the valve in nozzle 14 and opening, as desired, any other valves, for example, valves 56, 58, 62, in line between the waste water tank outlet and sewer inlet 68, thereby enabling fluid communication from the waste water tank(s), through hose 12, nozzle 14, adapter 32, 34, 36, 38 (as well as any extension hose/nozzle that may be installed in-line with the foregoing components), to the sewer inlet. Such other valves 56, 58, 62, if power-operated, could be opened remotely using a remote control provided at nozzle 14, as discussed above.

With the foregoing valves so aligned, flow of waste water may be established from waste water tanks 50, 52 to sewer inlet 68. The flow of waste water may be interrupted on demand by closing the valve in nozzle 14 and/or any other valves in line between the waste water tank(s) and nozzle 14. Such other valves, if power-operated, could be closed remotely using a remote control provided at nozzle 14, as discussed above.

Features shown and described in connection with a particularly embodiment generally could be used in other embodiments, unless context dictates otherwise. Embodiments disclosed herein are illustrative and should not be construed to limit the scope of the following claims.

1. A waste transfer system comprising:
a sewer hose having a hose inlet and a hose outlet; and
a sewer nozzle having a nozzle body, a nozzle interior, a nozzle inlet and a nozzle outlet, said nozzle inlet permanently attached to said hose outlet, a first quick disconnect fitting integrated with said nozzle outlet.

2. The system of claim 1 further comprising:
an adapter having an adapter body, an adapter inlet and an adapter outlet, a second quick disconnect fitting integrated with said adapter inlet;
said adapter inlet configured for substantially leak tight connection to said nozzle outlet;
said adapter outlet configured for connection to a sewer inlet of a sewer system.

3. The system according to claim 1, said nozzle further comprising a valve disposed within said nozzle body and operable from outside said nozzle body, said valve operable to selectively enable and disable fluid communication between said nozzle inlet and said nozzle outlet.

4. The system according to claim 1 further wherein said first quick disconnect fitting is a female cam lock connector.

5. The system of claim 5, wherein said second quick disconnect fitting is a male cam lock connector.

6. The system of claim 2, said adapter being at least partially transparent to allow visual access to an interior of said adapter body from an exterior of said adapter body.

7. The system of claim 2, said adapter having a threaded outlet portion.

8. The system of claim 2, said adapter having a step threaded outlet portion.

9. The system of claim 2, said adapter having a compression fitting outlet portion.

10. The system of claim 2, said hose inlet comprising a third quick disconnect fitting.

11. A waste transfer system comprising:
a waste water tank having a tank outlet;
a sewer hose having a hose inlet and a hose outlet, said hose inlet configured for fluid connection to said tank outlet;
a sewer nozzle having a nozzle body, a nozzle interior, a nozzle inlet and a nozzle outlet, said nozzle inlet permanently attached to said hose outlet, a first quick disconnect fitting integrated with said nozzle outlet; and
an adapter having an adapter body, an adapter inlet and an adapter outlet, a second quick disconnect fitting integrated with said adapter inlet;
said second quick disconnect fitting configured for substantially leak tight fluid connection to said first quick disconnect fitting;
said adapter outlet configured for fluid connection to a sewer inlet of a sewer system.

12. The waste transfer system of claim 11, said hose inlet comprising a third quick disconnect fitting and said tank outlet comprising a fourth quick disconnect fitting configured for substantially leak tight fluid connection to said third quick disconnect fitting.

13. The waste transfer system of claim 11, said nozzle further comprising a first valve disposed within said nozzle body and operable from outside said nozzle body, said first valve operable to selectively enable and disable fluid communication between said nozzle inlet and said nozzle outlet.

14. The waste transfer system of claim 11 further comprising at least one second valve connected between said tank outlet and said hose inlet.

15. The waste transfer system of claim 14, said at least one second valve being power operated.

16. The waste transfer system of claim 15, said at least one second valve being remotely controllable from said nozzle.

17. The waste transfer system of claim 11, said adapter comprising a threaded outlet portion.

18. The waste transfer system of claim 11, said adapter comprising a compression fitting outlet portion.

19. The waste transfer system of claim 11, at least a portion of said adapted being at least partially transparent to allow visual access to an interior of said adapter body from an exterior of said adapter body.

20. The system of claim 11, further comprising an extension hose/nozzle assembly comprising:
a second sewer hose having a second hose inlet and a second hose outlet, the second hose inlet configured as a second hose quick disconnect fitting, and
a second nozzle having a second nozzle inlet permanently attached to said second hose outlet and a second nozzle outlet configured as a second nozzle quick disconnect fitting.

21. A recreational vehicle comprising:
a waste water tank having an outlet;
a sewer hose having a hose inlet and a hose outlet, said hose inlet configured for substantially fluid tight connection to said tank outlet;
a nozzle having a nozzle body, a nozzle inlet and a nozzle outlet, said nozzle inlet permanently connected to said hose outlet, said nozzle outlet configured as a first quick disconnect fitting; and
an adapter having an adapter body, an adapter inlet, and an adapter outlet, said adapter inlet configured as a second quick disconnect fitting configured for substantially fluid tight connection to said first quick disconnect fitting, said adapter outlet configured for connection to a sewer inlet of a sewer system.
